(19) United States
(12) Patent Application Publication
(10) Pub. No.: US 2010/0086173 A1
(43) Pub. Date: Apr. 8, 2010

(54) Method and Device for Identifying Objects

(75) Inventors: Gisbert Berger, Berlin (DE); Katja Worm, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/515,019

(22) PCT Filed: Nov. 15, 2007
(86) PCT No.: PCT/EP2007/062387

§ 371 Date: Dec. 4, 2009

(30) Foreign Application Priority Data
Nov. 15, 2006 (DE) 10 2006 053 937.0

(51) Int. Cl. G06K 9/00

(52) U.S. Cl. 382/101

(57) ABSTRACT

In a method and a device for identifying objects, a signature is generated for each object in a first step, including characteristic features of the object and the objects are collected into object groups. In a subsequent step, after the completion of the first step, a distinguishing condition is derived from the signatures of the objects in the object group only for the objects of the group. In a subsequent step for identifying the objects of the object group, the distinguishing condition determined in the previous further step is used, wherein with specified matching of the distinguishing conditions, the object is identified in the subsequent step.

The invention relates to a method for identifying articles in which, for each article, a first step involves a signature being created and stored which comprises characteristic features of the article, and the articles being combined into groups of articles. The invention also relates to an apparatus for identifying articles with a computation unit for forming a signature for a depiction of the respective article as recorded by means of a camera, the signature comprising characteristic features of the article, and for associating the articles with a plurality of groups of articles which are then transported in combination.

Some industrial processes or management processes in which a multiplicity of articles of the same kind are handled require pictorial identification of the individual articles. By way of example, a postal process can be used in which mail items, for example a large number of letter mailings, are handled. The mailings are first of all registered pictorially, with characteristic features of the individual mailings being recorded and a signature being formed therefrom which can be used later in the process or in a subsequent process as a distinguishing criterion for each mailing, so that it is possible to retrieve a mailing. Such registration and identification is known from DE 40 00 603 C2, for example.

To identify a mailing, the surface of the mailing is scanned again and a fresh signature is formed which is compared with the stored signatures for the registered mailings. For this purpose, the signatures are considered to be vectors in a feature space and the interval between the fresh signature and the known signatures is formed. A mailing is deemed to have been identified when the interval between two vectors is minimized.

Reliable application of this method requires the identification to be able to be performed with a low error rate. For this, weights of individual features and rejection criteria for rejection of unidentified articles are determined experimentally by identifying large quantities of conceivable articles and obtaining the experimental results therefrom. Particularly when comparing very different mailings from mailbox mail and additionally very similar bulk mailings, errors may arise, however, since more stringent rejection criteria should be applied in the case of very similar bulk mailings, in order to avoid misidentification, than in the case of very different mailbox mail.

EP 1 222 037 B1 discloses a method having the features of the preamble of claim 1 and an apparatus having the features of the preamble of claim 9. The method and the apparatus produce a first restriction in the search space for mailings and therefore use an image-based method to simplify further identification of mailings which need to be sorted. In this case, a physical reduction in the search space is used in a mail sorting process.

The object of the invention is to provide a method having the features of the preamble of claim 1 and an apparatus having the features of the preamble of claim 9 which are able to be used to reliably and quickly identify articles which may be very different.

The object is achieved by a method having the features of claim 1 and an apparatus having the features of claim 9. Advantageous refinements are specified in the subclaims.

The inventive method for identifying articles provides for a first step, an intermediate step and a subsequent step to be performed.

The first step involves a respective signature being produced and stored for each article. This signature is produced using a depiction of the article and comprises characteristic features of the article. The first step also involves the articles being combined into at least two groups of articles. Each article is associated with one group of articles.

The intermediate step involves at least one distinguishing criterion being derived for at least one group of articles. This distinguishing criterion can be used to distinguish the articles in this group of articles. The distinguishing criterion is derived from the signatures of the articles in this group of articles.

The subsequent step involves each article being identified. This identification involves the following substeps being carried out for each article:
A signature for the article is produced again. To produce this signature again, a further depiction of the article is used.
The freshly produced signature is compared with stored signatures. This involves a comparison being performed with some or all stored signatures.

For the articles in at least one group of articles, the comparison involves the following substeps being performed:
A respective degree of match between the produced signature and a stored signature is calculated.
The article is identified if a degree of match reaches or exceeds a prescribed limit.

In this case, the invention is based on the consideration that certain features have a good distinguishing capability for some articles and a poor distinguishing capability for other articles, since the articles are very similar in this very property. Whereas a first feature can be used very well for distinguishing one group of articles, it may be less suitable for another group.

In addition, the individual characteristic features may have different value ranges and are therefore preferably normalized for the purpose of suitable distinction. The value ranges for individual features may be very different depending on the type of mailing, which means that a suitable normalization for a first type of articles may turn out differently than for another type of articles.

One advantage of the invention is as follows: the distinguishing criterion for the group of articles can be calculated between the first and the subsequent step, that is to say effectively offline. Usually, there is much more time available between the first and subsequent steps than during the subsequent step, in which each article needs to be identified within a prescribed period of time. It is therefore advantageous to give preference to computation steps from the subsequent step. The invention shows a way of doing this.

In addition, the finding of a suitable rejection criterion is of great significance. Thus, by way of example, although a signature from an article which is not registered at all, for example on account of a double feed, may exhibit an extremely small difference or interval from any registered article, this difference will be very large in this case, since it is not two signatures from the same article but rather two signatures from different articles that are being compared with one another. It is therefore necessary to find a minimum difference or minimum interval between signatures which it is necessary to be below for identification. Depending on the distinguishability of articles, this minimum interval may be large for one group of articles and small for another group, however.

The invention is based on the further consideration that the handled articles may be able to be divided into groups of articles, for example in a sorting process in which all articles at a sorting destination are placed into one container, and a group of articles of this kind is placed into the apparatus for identification together as a group again in a subsequent identification process. If this group of articles is already known prior to the identification, it is possible for suitable distinguishing criteria to be formed specifically for the articles in this group of articles, said distinguishing criteria being able to be used to reliably distinguish the articles in this group of articles from one another but possibly being less suitable for distinguishing articles in another group. A reliable distinguishing criterion can therefore be obtained from a property of the group of articles, for example a type of distinguishability of the articles in the group of articles. This means that it is possible to achieve identification or rejection of articles with a low error rate.

The articles are preferably mail items, such as mailings, e.g. letters of all sizes, printed matter, periodicals or the like. Printed products, particularly documents, forms, slips, labels and the like are likewise conceivable. The invention is not limited to said articles, however. The characteristic features may be features of the surface of an article, particularly visual features such as color, shape and brightness of overprints, number of type of overprinted areas, such as words, lines or graphics, and/or layers and sizes of such areas absolutely on the article or relative to one another. The identification of the article is expediently achieved through comparison of the signature with a multiplicity of signatures, formed during an earlier registration, from articles in a search space.

The property of the group of articles may be a property of the articles in this group of articles, such as a property of the signature of these articles, particularly a difference between the signatures of these articles, for example on the basis of one of the characteristic features.

The distinguishing criterion is not formed until after all the articles in a group of articles have been associated with this group of articles. Only then is the space for all the signatures in this group of articles known and the distinguishing criterion can be matched to this space in what is known as a consolidation process.

Simple classification of the groups of articles can be achieved if the groups of articles are classified on the basis of sorting criteria for the articles. These may already be known during the registration, which means that later, separate association of the articles can be dispensed with.

All the articles in the group of articles are compared with one another in respect of at least one characteristic feature. It is possible to record a diversity in the articles in respect of this feature and to match the distinguishing criterion to this diversity. Expediently, the articles are compared with one another in respect of a plurality of features, which means that the distinguishing criterion can be matched to a plurality of diversities.

Particularly in the case of bulk mailings, it may arise that an inherently characteristic feature is not suitable for distinguishing the articles, since the articles are the same in respect of this feature. It is then expedient to recognize this feature in order to exclude it from the catalogue of features with high suitability for distinction, if appropriate. For this, at least one of the characteristic features is examined for its distinguishing capability within the group of articles in order to create the distinguishing criterion.

In order to accentuate features which are capable of distinction over features which are less capable of distinction for the purpose of identification, it is advantageous if the distinguishing criterion comprises a weighting for characteristic features. This weighting expediently takes account of the distinguishing capability found for the features within the group of articles.

Since individual features can have different value ranges, they should be normalized in a suitable manner in order to allow features to be compared with one another. In this case, the features of the articles in the group of articles can have their value ranges examined, so that the features are normalized in optimum fashion for this group of articles. Expediently, the distinguishing criterion therefore comprises a normalization for characteristic features.

Within a group of articles, for example within mailings in a mailing container, it may arise that there are subgroups of different articles, e.g. two kinds of bulk mailings. In this case, a feature may be good for distinguishing one subgroup but not for distinguishing the other subgroup. Classification of a group of articles into subgroups, with the distinguishing criterion being stipulated differently for the subgroups, can take account of such a configuration and ensure that the distinguishing criterion is chosen advantageously for both subgroups.

It is possible to achieve an even more finely differentiated stipulation of the distinguishing criterion if said criterion is stipulated individually for a plurality of articles in the group of articles, in particular is stipulated individually for each article in the group.

A reliable rejection criterion can be determined if the distinguishing criterion comprises a minimum difference between the articles in respect of one of the characteristic features. If the signature of an article to be identified is more similar to a stored signature than stipulated by the minimum difference, it is possible to assume largely safe identification. By virtue of the fact that a signature formed during registration for an article may be slightly different than the signature formed when the same article is identified, the minimum difference should be greater than this diversity. This diversity may arise as a result of a cancellation mark applied between the registration and the identification, for example, or as a result of an address field for a mailing that has slipped in an envelope.

In this case, the minimum difference may be a global minimum difference which is the same for all articles in the group, or it may be different for some or all of the articles in the group of articles. Advantageously, the signature can be represented by a vector, and the distinguishing criterion comprises an interval between vectors.

The object relating to the apparatus is achieved by an apparatus for identifying articles of the type cited at the outset in which, in line with the invention, the computation unit is provided for the purpose of using a further step, following conclusion of the first step, to ascertain a distinguishing criterion, derived from the signatures of the articles in this group of articles, only for the articles in this group of articles and, in a subsequent step, to use the distinguishing criterion ascertained in the further step to identify the articles in this group of articles.

The invention is explained in more detail with reference to exemplary embodiments which are shown in the drawings, in which:

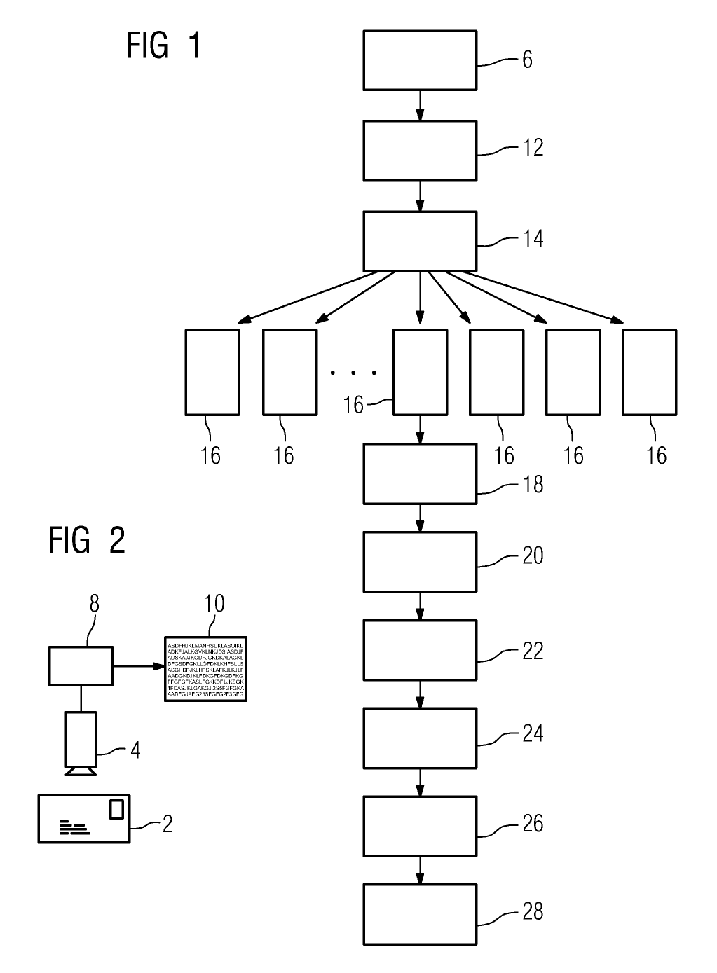

FIG. 1 shows a flowchart for a method for sorting articles which comprises a method for identifying articles,

FIG. 2 shows a computation unit which produces a signature from an image of an article,

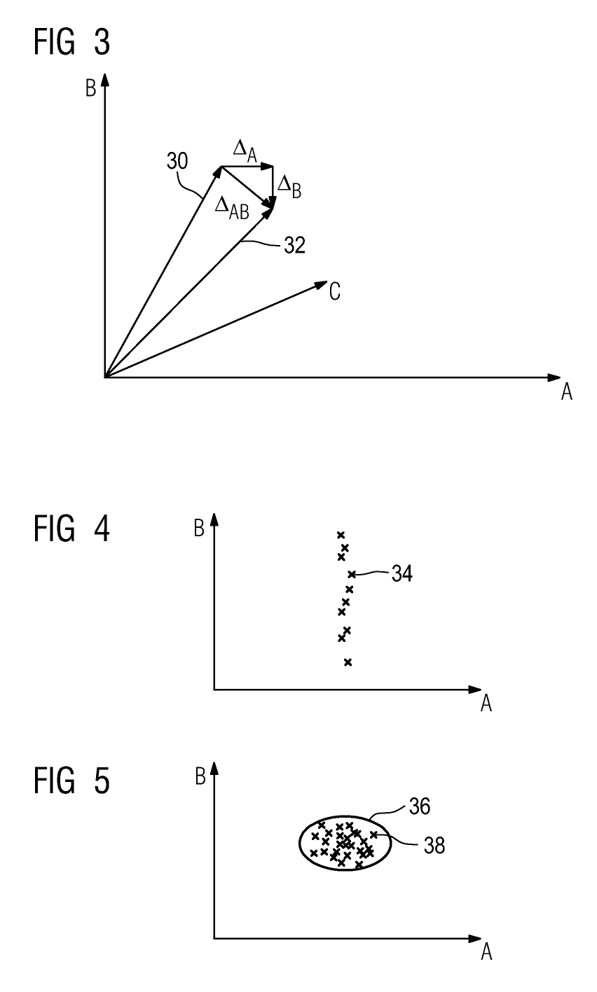

FIG. 3 shows two signature vectors in a three-dimensional feature space,

FIG. 4 shows a group of signature vectors in a two-dimensional feature space,

FIG. 5 shows a vector cluster in the feature space,

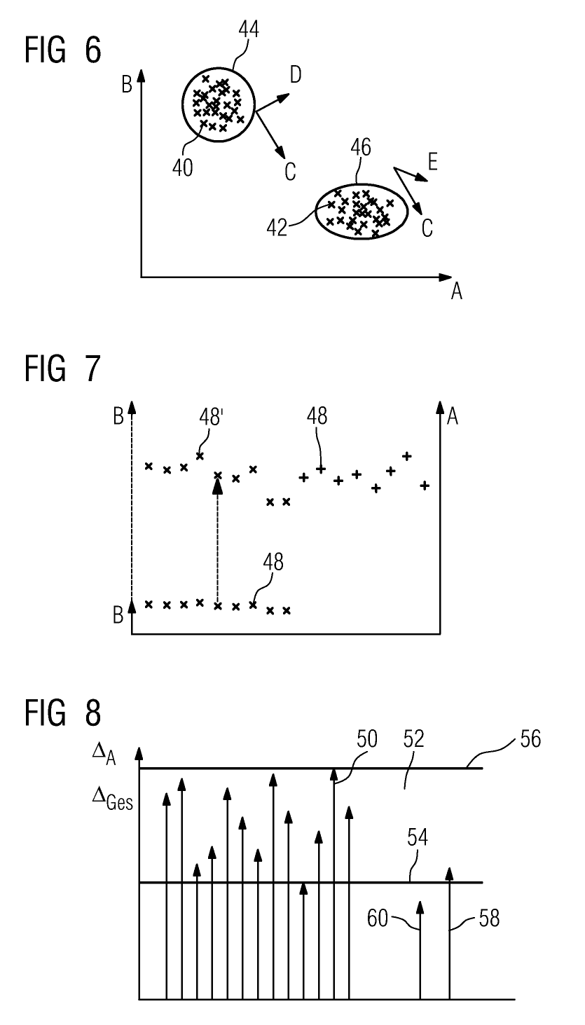

FIG. 6 shows two different vector clusters in the feature space,

FIG. 7 shows the normalization of vectors in a feature dimension, and

FIG. 8 shows intervals between feature vectors to form a spacer band.

FIG. 1 shows an outline diagram of a sequence for a method for sorting articles, in the specific case of mail items, such as letter mailings, which comprises a method for identifying the articles. FIG. 2 shows an apparatus controlling the methods. In a first sorting pass, mailings 2, as represented schematically by means of a letter, for example, in FIG. 2, are scanned by a camera 4, and the recorded image is used by a computation unit 8 in a signature formation step 6 during the registration to form a signature 10 for each mailing 2 from characteristic surface features of the respective mailing 2 on the basis of a stipulated specification. Next or beforehand, the address of each mailing 2 is read 12 purely automatically or using video encoding. The address is taken as a basis for sorting 14 the mailings 2 into a number of containers 16, each container 16 having 50 associated zip codes, for example. Each container 16 bears an identification number by means of which it can be explicitly recognized, for example by the computation unit 8 in conjunction with a reader.

Once the container 16 is full or the sorting process of the first sorting pass has concluded, the container 16 is closed 18 and it is henceforth assigned no further mailings 2. From now on, the container 16 is closed, and the mailings 2 stored in it form a complete group of articles. Since the mailings 2 have been sorted into all of the containers 16 on the basis of their address, the groups of articles have been classified on the basis of sorting criteria for the articles. The computation unit 8 now knows which mailings 2 are in one or more closed containers 16 and which signatures 10 stored in a database are associated with these mailings 2.

In a subsequent consolidation step 20, described in more detail for FIGS. 3 to 8, the computation unit 8 examines the signatures 10 of the mailings 2 in one or more containers 16. This consolidation is described by way of example with reference to a container or the group of articles thereof. The computation unit 8 takes the signatures 10 from the group of articles and ascertains a distinguishing criterion which can be used, during a subsequent identification step 26 for one of the mailings 2 from the container 16, to distinguish this mailing 2 or its signature 10 from the other mailings 2 or their signatures 10. The distinguishing criterion is therefore created on the basis of a property of the group of articles, since this distinguishing criterion is formed by examining some or all of the signatures 10 from the mailings in the container 16.

Before, during or after the consolidation step 20, the containers 16 are supplied 22 to a new sorting pass. The identification number on the container allows the computation unit 8 to recognize which group of articles is currently awaiting examination or sorting. Depending on whether the containers 16 are supplied to the same sorting installation or to a sorting installation in a different mail distribution center, there is more or less time available for the consolidation step 20. In the new sorting pass, the same or a different computation unit 8 forms 24 a fresh signature 10 for all mailings 2 from fresh pictures of the mailings 2. The computation unit 8 additionally knows to which group of articles these signatures 10 ought to belong. In a subsequent identification step 26, each freshly formed signature 10 is compared with some or all of the previously recorded signatures 10 from the group of articles and—as far as possible—each signature 10 has an earlier signature 10 associated with it. In this case, the association can be made using the consolidation results, the association being able to be made on the basis of the distinguishing criteria thereof. It does not need to be made on the basis of these criteria, however, because it may be a mailing 2 which can be explicitly identified in the group of articles even without these criteria, for example one with an explicitly identifiable bar code. Such a mailing 2 can be identified without any further methods.

The identification step 26 for the mailings 2 allows data additionally stored for the earlier signature 10 in a data record, such as the address of the mailing 2, its size, weight, rigidity, franking etc., to be freshly associated with the mailing 2 without having to weigh the mailing 2 again or the like. Finally, the mailings 2 are sorted 28 again and more finely using the address linked to the signature 10 found.

Details of the consolidation step 20 are shown schematically in FIGS. 3 to 8. FIG. 3 shows two signatures 10, represented as signature vectors 30, 32, in a multidimensional feature space which, for the sake of clarity, is limited to three dimensions which are determined by the characteristic features A, B and C. The two signature vectors 30, 32 differ from one another somewhat, i.e. the surfaces of the relevant mailings 2 that are scanned by the camera 4 are somewhat different than one another. In respect of feature A, the signature vectors 30, 32 differ from one another by the difference Δ_{A}, and in respect of feature B, they differ from one another by the difference Δ_{B}. The total difference Δ_{AB} is the vectorial sum of the two differences Δ_{A} and Δ_{B}. All of the differences Δ_{A}, Δ_{B}, Δ_{AB} can be regarded as intervals between the two signature vectors 30, 32 in respect of feature A, or feature B or of both features A, B together.

In respect of feature C, the signature vectors 30, 32 do not differ from one another, which means that in this case the difference is zero. Feature C is therefore not suitable for distinguishing the two signature vectors 30, 32 or the corresponding mailings 2.

For the sake of simplicity, FIG. 4 shows a number of signature vectors 34 as crosses in a two-dimensional feature space for the features A, B. The signature vectors are formed from signatures 10 from very similar mailings 2, for example mailings 10 from a large customer or unaddressed mailings. The signature vectors 34 differ from one another in respect of feature B, whereas their difference in respect of feature A is so small that this difference may stem from a measurement or evaluation tolerance during recording or evaluation of the images of the mailings 10. Feature A is therefore not suitable for use for distinguishing the signatures 10.

If, in a simplified illustration, the signature vectors 34 represent all of the mailings 2 in a container 16, the computation unit 8 will ascertain that feature A is unsuitable for later identification of a mailing 2 from this group of mailings. A distinguishing criterion for the mailings 2 in this group can therefore be obtained from a property of the group, namely the difference between the signatures 10 of this group, in this case that feature A is given a low weighting or is not used at all for distinction, but feature B is suitable and is used.

FIG. 5 shows a cluster 36 of signature vectors 38 which are very close to one another in respect of features A and B. If the consolidation step 20 now involves one or more of the characteristic features A, B being examined by the computation unit 8 for their distinguishing capability within the group of articles in order to create a distinguishing criterion, the computation unit 8 will ascertain that these signature vectors 38, or the bulk mailings behind them, cannot be distinguished using features A, B. The distinguishing criterion therefore comprises the information that features A, B are not sufficiently good for distinction and need to be used for identifying other features, in the case of exclusion or low weighting of features A, B.

An example relating to this is shown in FIG. 6. A container 16 contains a multiplicity of two different bulk mailings whose signature vectors 40, 42 form two clusters 44, 46. Both the signature vectors 40 and the signature vectors 42 differ from one another within a cluster 44, 46 only by short intervals Δ_{A}, Δ_{B}. However, the signature vectors 40 can easily be distinguished from the signature vectors 42 by means of the features A, B. The computation unit 8 will therefore stipulate as a distinguishing criterion that the features A, B can be used to limit the search space to one of the clusters 44, 46. Within the clusters 44, 46, it is necessary to find other features for the distinction.

From the comparison of the signatures 10 in the consolidation step 20, the computation unit 8 ascertains, by way of example, that feature C, e.g. the number of characters in the addresses—ascertained from the size of a grey area of a coarse-resolution image of the mailings 2—can be used for distinguishing the signature vectors 40 of the cluster 44. In addition, feature D is suitable, e.g. the number of characters in the destination of the address. For the cluster 46, the computation unit 8 establishes that although feature C is likewise suitable, feature D is not, since the grayscale values for the destination are all the same. In this example, the mailings 2 all have the same destination, e.g. Hamburg. Instead of feature D, the computation unit stipulates a further feature E for distinguishing the signature vectors 42 of the cluster 46, e.g. the length of the recipient's name or of the second line of the address.

If an identification process 26 involves a signature 10 being associated with one of the clusters 44, 46 by the features A, B, the computation unit 8 will seek to distinguish this signature 10 or its signature vector 40, 42 from the other signature vectors 42, 44 according to clusters 44, 46 using features C and D or C and E. In this way, it is possible to classify a group of articles into subgroups and the distinguishing criterion can be stipulated differently for the subgroups. In the extreme case, a subgroup may comprise a single mailing 2, which means that a distinguishing criterion is stipulated individually for this—or in even more of an extreme case—for each article in the group.

FIG. 7 shows signature vectors 48 which differ in respect of features A and B. The signature vectors 48 are plotted as diagonal crosses as a function of feature B and as straight crosses as a function of feature A in FIG. 7. The dependency of the signature vectors 48 on features A, B is characterized in that the values of the signature vectors 48 are much lower for feature B than for feature A, however. In this example, feature B is just as important for distinction as feature A, however. To allow weighting-matched distinction using features A, B, the signature vectors 48 are normalized for feature B such that their values correspond to those for feature A. This is expressed in FIG. 7 by the dashed arrows. In this case, the signature vectors 48′ are formed using values which are similar in features A, B, and these signature vectors 48′ are used for distinction.

FIG. 8 shows a further distinguishing criterion using intervals 50 between signature vectors. It may arise that a mailing 2 cannot be identified in the method step of identification 26 and needs to be rejected. One cause may be that two mailings 2 sticking to one another are singularized cohesively in a double feed, and the back mailing 2 has not been detected during the signature formation step 6 in the registration, but the mailing 2 has been sorted into the same container 16 as the front mailing 2. If the later sorting pass involves the signature 10 of the previously rear mailing 2 being sought in the signatures 10 from the group of articles in the container 16, the signature 10 cannot be associated with a first signature 10 and the mailing 2 therefore cannot be recognized. Rejection requires a rejection criterion as a special distinguishing criterion.

The formation of such a rejection criterion is shown schematically in FIG. 8. First of all, the property of the group of articles is ascertained by comparing all the signature vectors with one another in respect of at least one characteristic feature such that an interval 50 Δ_{A} between a signature vector and all other signature vectors is ascertained for a feature. It is also possible to relate the interval 50 to a plurality of or all of the features A, . . . Z, so that a respective interval 50 Δ_{Ges} is obtained—for an interval based on all the features. This results in a number of intervals 50 Δ_{Ges} for this signature vector or Δ_{A} for all other signature vectors. A similar process is used for all of the signature vectors, so that finally every interval 50 from every signature vector to every other signature vector is known. These intervals 50 form a spacer band 52 with a bottom edge, which represents a minimum interval 54, and a top edge 56. This minimum interval 54 is a rejection criterion.

If an identification step 26 now involves a new signature vector for a mailing 2 which is to be identified being compared with the signature vectors which are known from the group, a very small interval 58 is obtained with respect to one of the known signature vectors, namely with respect to the one which is most similar to the new signature vector. The new signature vector is therefore closest to this known signature vector. If this interval 58 is above the minimum interval 54, the mailing 2 to be identified is less similar to the most similar mailing 2 from the container 16 than another mailing 2 in the container 16. Identification is therefore possible with barely any reliability and the new mailing 2 is rejected as unidentified or as unidentifiable. If a interval 60 is below the minimum interval 54, however, the mailing 2 to be identified is more similar to the most similar mailing 2 from the container 16 than any other mailing 2 in the container 16. In this case, the corresponding new mailing 2 is deemed to have been identified.

In a simplification of the method, it is possible to stipulate a minimum difference 54 for each mailing 2. Five signature vectors from a group of articles are considered by way of example. Each of these signature vectors is compared with all other signature vectors. In this case, each signature vector has a very small interval from another, for example signature vector No. 1 has the smallest interval ΔIₘᵢₙ. This smallest interval can be obtained for one, a plurality of or all features, according to the distinguishing criterion which has been described as for FIGS. 3 to 7, for example. In the example which follows, the respective total interval is formed for all sufficiently distinguishing features. For the five signature vectors used by way of example, the following smallest total interval ΔGₘᵢₙ will be obtained in each case:

Signature vector No. 1: ΔG1ₘᵢₙ=55.6
Signature vector No. 2: ΔG2ₘᵢₙ=80.8
Signature vector No. 3: ΔG3ₘᵢₙ=77.1
Signature vector No. 4: ΔG4ₘᵢₙ=43.0
Signature vector No. 5: ΔG5ₘᵢₙ=61.9

The smallest total interval between the first signature vector and all other signature vectors is therefore 55.6, for example, and the global minimum interval 54 that applies for the entire group of articles and that is stipulated by the bottom edge of the spacer band is 43.0.

If a new signature vector is compared with all known signature vectors in an identification process, the result will be, by way of example, that the new signature vector is closest to the known signature vector No. 2 with a interval of 51.0. This value is above the minimum interval 54 of 43.0, which means that the new signature vector could be rejected. However, the minimum interval ΔG2ₘᵢₙ for the second signature vector is 80.8. The new signature vector—although above the global minimum interval 54—is therefore closer to the second signature vector than all other known signature vectors. In this case, the individual minimum interval ΔG2ₘᵢₙ for the second signature vector of 80.8 can be stipulated as a rejection criterion, which means that the new signature vector is deemed to have been identified.

In this way, both very different mailings 2 from mailbox mail and very similar mailings 2 from bulk mailings can be identified with a low rejection rate and a low error rate.

1-9. (canceled)

10. A method for identifying articles in a plurality of process steps, the method which comprises:
a first step, to be performed for each article:
producing a signature with characteristic features of the article by using an image of the article, and storing the signature;
combining the articles into at least two groups of articles;
subsequently deriving, for at least one respective group of articles, at least one distinguishing criterion from the signatures of the articles in the respective group of articles for distinguishing the articles in the respective group of articles;
a subsequent step for identifying each article, the identifying step including the following substeps:
producing a new signature of the article by using a further image of the article; and
comparing the new signature with the signatures stored in the first step, and, further, for each article in the respective group of articles:
calculating a respective degree of match between the new signature and the stored signature; and
identifying the article by way of an association between a stored signature and the new signature if a degree of match reaches or exceeds a prescribed limit.

11. The method according to claim 10, which comprises classifying (14) the groups of articles on a basis of sorting criteria for the articles.

12. The method according to claim 10, which comprises defining a distinguishing criterion with a prescribed weighting for at least two of the characteristic features.

13. The method according to claim 10, which comprises defining a distinguishing criterion with a normalization for prescribed characteristic features.

14. The method according to claim 10, which comprises deriving further features from the signatures in the group of articles.

15. The method according to claim 10, which comprises:
classifying a group of articles into subgroups; and
deriving a respective distinguishing criterion for each subgroup for distinguishing the articles in the group of articles and using the distinguishing criterion identifying the articles in the subgroup.

16. The method according to claim 10, which comprises stipulating a respective distinguishing criterion individually for a plurality of articles in the group of articles.

17. The method according to claim 10, which comprises commonly transporting all articles of a group of articles together via a transport path.

18. An apparatus for identifying articles, the apparatus comprising:
a computation unit configured to produce and store a signature for each article using a depiction of the article, the signature containing characteristic features of the article;
a grouping unit configured to combine the articles into at least two groups of articles;
said computation unit being configured to subsequently derive, for at least one group of articles, at least one distinguishing criterion from the signatures of the articles in the group of articles for the purpose of distinguishing the articles in the group of articles;
said computation unit being configured to identify each article in a subsequent identification step, performed with substeps in which said computation unit, again using a further depiction of the article, produces a new signature for the article and compares the new signature with stored signatures; and
said computation unit further being configured to compare, for each article in the group of articles, the new signature with the stored signatures, and thereby to:
calculate a respective degree of match between the new signature and a stored signature; and
identify the article by way of an association between a stored signature and the new signature if a degree of match reaches or exceeds a prescribed limit.
